(19) United States
(12) Patent Application Publication
(10) Pub. No.: US 2026/0229794 A1
(43) Pub. Date: Aug. 6, 2026

(54) ELECTRICAL TERMINAL AND ASSEMBLY

(71) Applicant: Cooper-Standard Automotive Inc., Northville, MI (US)

(72) Inventor: David S. Malone, Attica, MI (US)

(73) Assignee: Cooper-Standard Automotive Inc., Northville, MI (US)

(21) Appl. No.: 19/047,608

(22) Filed: Feb. 6, 2025

(51) Int. Cl. H01R 4/48; H01R 43/26

(52) U.S. Cl. CPC H01R 4/48; H01R 43/26; H01R 2201/26

(57) ABSTRACT

This disclosure relates to an electrical terminal having a body for connecting to a conductor and defining a loop. A tab extends into the loop having a deflectable end projecting away from the body and providing a pin socket between the loop and the tab. A pin terminal can be inserted into the pin socket with a reduced force.

### FIELD

The field is related to an electrical terminal and terminal assembly for electrically connecting electrical components in a secure manner, and particularly in automotive applications.

### BACKGROUND

Electrically operated fluid pumps are known and commonly used to move fluids in thermal management systems, such as coolant in a vehicle. One example of a thermal management system is the cooling of battery systems of a hybrid or purely electric vehicle. The fluid pumps are operated at various speeds to increase or decrease the flow of coolant through the thermal management system based on demand signaled from a vehicle central computer. Valves may be used in conjunction with the fluid pump to regulate flow from the pump to ensure the distribution of the coolant throughout the thermal management system. The valves may also be used to switch fluid into the pump from various devices that the pump serves. The valves each require use of an electrical actuator motor that drives the valve to switch the flow of coolant from the valve or into the valve.

Currently known fluid pumps include a valve integrated with the fluid pump, where the electrical motor that moves the valve is located within the same housing as the electrical motor that drives the pump. Both devices are packaged as a single integrated unit. Power and control signals for operating the electrical motor and the valve actuator of the electrical motor are provided from motor drivers located at the vehicle's central computer. The motor drivers are commanded by the vehicle central computer to energize the electrical pump motor at various pump speeds and/or to activate the actuator motor to position the valve in several switched positions. Additionally, the actuator may include a position sensor that provides feedback signals back to the motor drivers that report the current switched position of the valve. Power and control connections between an integrated pump and valve and the remotely located motor drivers use separate wiring bundles that each separately connect the fluid pump and the valve resulting in wiring complexity and high component costs

### SUMMARY

This disclosure relates to an electrical terminal having a body for connecting to a conductor and defining a loop. A tab extends into the loop having a deflectable end projecting away from the body and providing a pin socket between the loop and the tab.

This disclosure also relates to an electrical assembly having an electrical terminal comprising a body for connecting to a conductor and defining a loop. A tab extends into the loop having a deflectable end projecting away from the body and providing a pin socket between the loop and the tab. A pin terminal is positioned in the pin socket in contact with the tab and is spaced from the loop.

This disclosure also relates to a method for making an electrical connection including the step of providing an electrical terminal comprising a body for connecting to a conductor and defining a loop. A tab extends into the loop having a deflectable end projecting away from the body and providing a pin socket between the loop and the tab. Further, providing a pin terminal and inserting the pin terminal into the socket using a force of less than about 7 N.

### BRIEF DESCRIPTION OF THE DRAWINGS

FIG. 1 is a top plan view of a terminal of the present invention.

FIG. 2 is a is a top plan view of a terminal and conductor assembly of the present invention.

FIG. 3 is a perspective view of a terminal and pin terminal prior to insertion into a socket of the terminal.

FIG. 4 is a perspective view of a terminal and a pin terminal in cooperative engagement.

FIG. 5 is a perspective view of an array of five terminal and pin terminal assemblies.

FIG. 6 is a perspective view of an array of five terminal and pin terminal assemblies connected to a lead frame.

FIG. 7 is graph of reaction force (N) vs. time (sec) generated during an insertion of a pin terminal into a socket of a terminal to show resultant (selection) with a triangle divided line.

FIG. 8 is a top plan view of an array of five terminal and pin terminal assemblies.

FIG. 9 is a perspective view of array of five terminal and pin terminal assemblies connecting a pump to a power source and a valve sensor board.

While the following is described in conjunction with specific embodiments, it will be understood that this description is intended to illustrate and not limit the scope of the preceding description and the appended claims.

### DETAILED DESCRIPTION

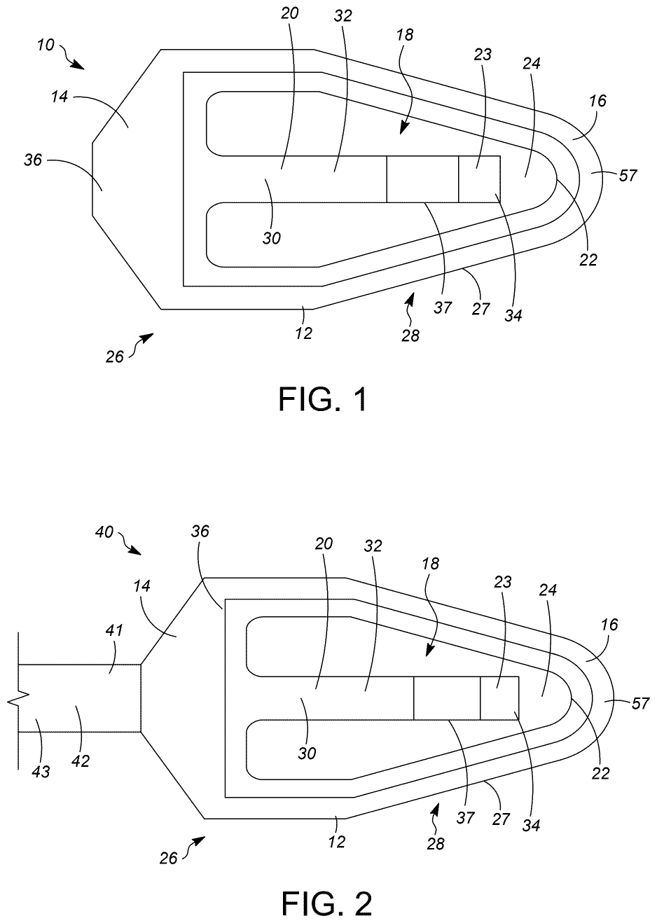

FIG. 1 shows a socket terminal 10 having a body 8 at a first end 14 and a strip 12 that loops from body 8 that defines a radiused section at a second end 16 and returns to the body 8 to define an enclosed space 18 in a loop 22. A tab 20 extends from the strip 12 into the loop 22 having a deflectable end 23 providing a pin socket 24 between the loop 22 and the tab 20. The strip 12 has a rectangular cross section 26. Tapering segments 27 of the strip extend from the body 8 to a radiused section 28 that define a bight 57 that completes the loop 22. The tab 20 has a proximal end 30 having a first upper surface 32 and the deflectable end 23 has a second upper surface 34. The first upper surface 32 may be coplanar with a top surface 36 of the strip 12 and the second upper surface 34 extends beyond a top surface 36 of the strip 12, hence, it is not coplanar therewith. The deflectable end 23 may be bent to extend from the base 8 at least one of the thickness of the tab or greater. The tab 20 has a polygonal shape in vertical cross section. The polygonal shape includes squares and rectangles for example. While the tab 20 is shown having two parallel lateral edges 37, the lateral edges 37 can have shapes that are not straight lines but have irregular shapes and the shape of one lateral edge 37 can differ from the other lateral edge 37. Preferably, the strip 12 and the tab 20 are of unitary construction from an electrically conductive material and are formed, for example, by stamping. Electrically conductive materials include metals such as iron, copper, silver, gold, aluminum, and metal alloys such as brass, bronze, steel, or other conductive material well known to those of ordinarily skill in the art.

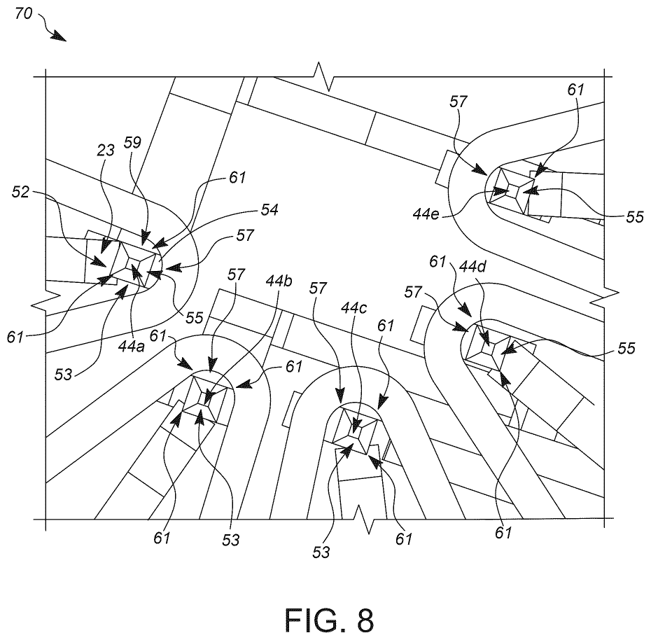

FIG. 2 shows an assembly 40 of the socket terminal 10 connected to a first end of 41 of an electrically conductive element 42. All the reference numerals of FIG. 1 are repeated in FIG. 2. In one aspect, the socket terminal 10 and the conductive element 42 are of unitary construction and are formed by stamping from a sheet of the electrically conductive material. It is also possible for the electrically conductive element 42 to be an electrically conductive wire, bar or other electrically conductive element that is attached to the socket terminal 10 by soldering or other technique known to one of ordinary skill in the art. An opposed second end 43 of the conductive element can be connected to, for example, an electrical component such as an electrical power source, a pump motor, a valve actuator motor, a valve position sensor, and a mother board of a control unit as shown in FIG. 8.

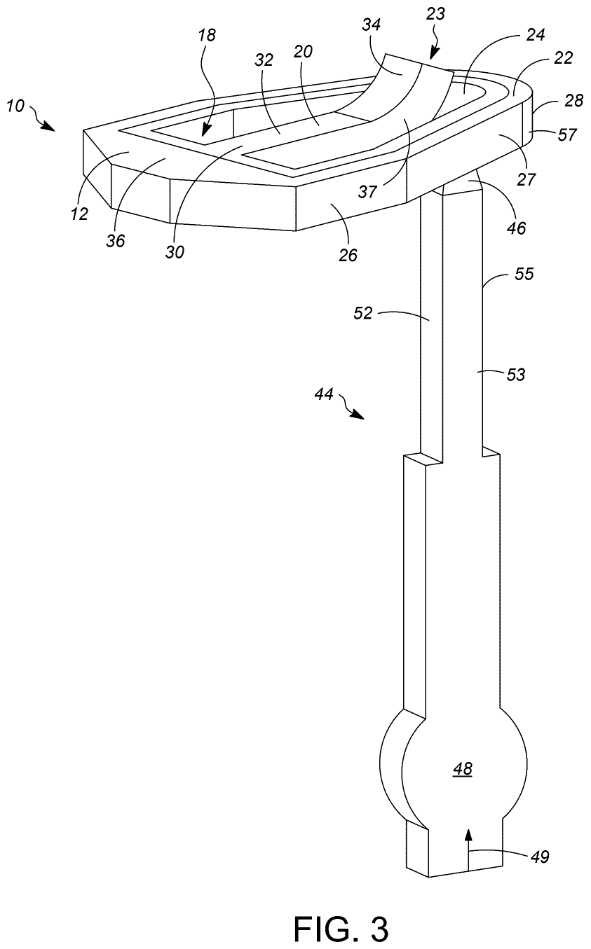

FIG. 3 shows the socket terminal 10 adjacent to a pin terminal 44 just prior to insertion of the pin terminal 44 into the pin socket 24. The pin terminal 44 has a generally square or rectangular shape in horizontal cross section having four faces including a first face 52, an opposed second face 55 a third face 53, and a fourth face (not shown) with each face joined to an adjacent face at a corner edge 61. The polygonal shape that provides corner edges reduces the surface area contact with the circular shaped pin socket 24 to reduce friction between the parts to reduce the insertion forces. The pin terminal 44 has an insertion end 46 that may be shaped as a square pyramid and more preferably a truncated square pyramid. Even off-target insertion efforts—where the pin is not precisely aligned with a center line of the pin socket 24—the pin terminal can be directed into correct alignment when a surface of the insertion end 46 contacts an inner surface of the pin socket 24. The pin terminal 44 also has a length longer than standard compliant pins to allow for a greater range of mating distances between parts being connected. The longer length avoids tolerance buildup between mating parts that may lead to distances between parts that exceed the length of the standard compliant pin terminal rendering the standard compliant pin terminal ineffective. The pin terminal 44 is sufficiently long such that the insertion end 46 of the pin terminal extends past engagement with the deflectable end 23 when fully mated. The pin terminal 44 has a broad surface 48. The insertion direction is shown by arrow 49 on the broad surface 48.

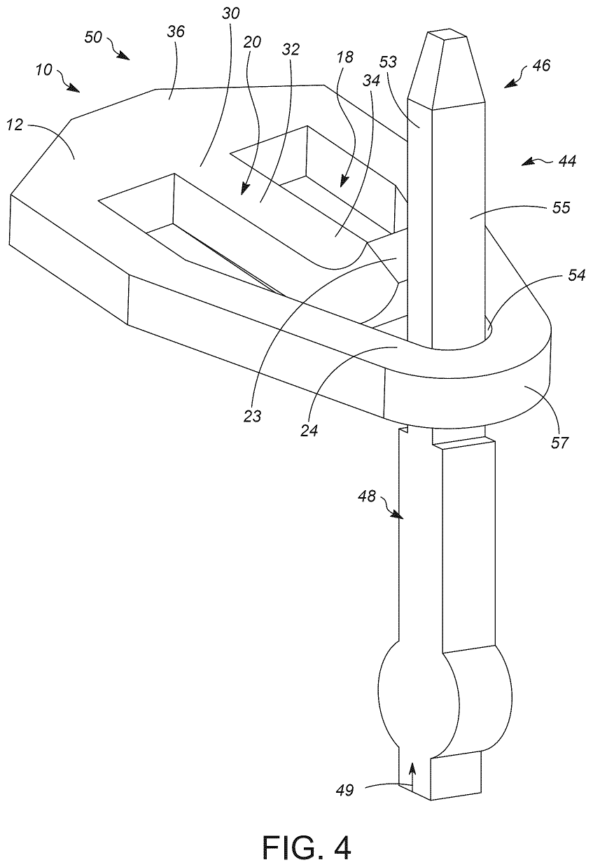

FIG. 4 shows an assembly 50 of the pin terminal 44 inserted into the pin socket 24 where the deflectable end 23 of the tab 20 cooperatively engages the first face 52 (FIG. 3) of the pin terminal 44 causing the deflectable end 23 to deflect upwardly and the pin terminal 44 to bend away from the pin socket 24 as shown in the FIG. 4. In FIG. 4, the location of the fourth face 59 is indicated. It is desirable to reduce the insertion forces by minimizing the surface area where the parts contact each other during insertion. Preferably, the only contact between the socket terminal 10 and the pin terminal 44 is between the deflectable end 23 of the tab 20 and a portion of one of the faces 52, 53, 55, 59 of the pin terminal 44 and/or a portion of one of the corners 61. The pin terminal 44 may have any of its faces and or corners in contact with the tab 20 during insertion and when in the final position. In a preferred aspect, a gap 54 is formed between the opposed second face 55 of the pin terminal and an interior surface of the bight 57 of the strip 12 during insertion and when in its final position

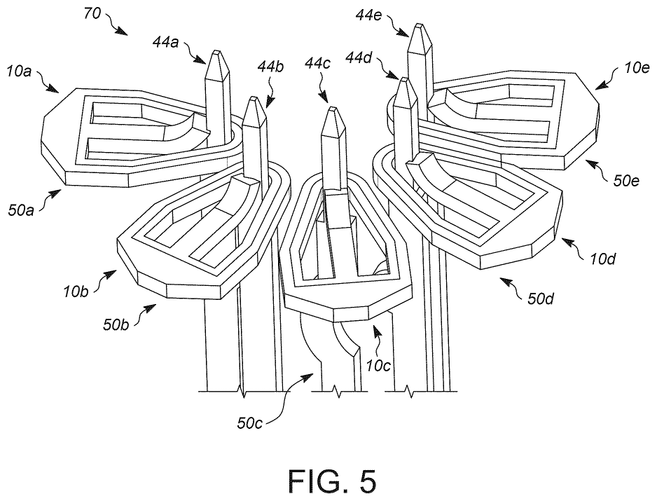

FIG. 5 shows an array 70 of five terminals 10a,b,c,d,e electrically connected at one end to associated pin terminals, 44a,b,c,d,e to define five assemblies 50a,b,c,d,e, respectively. While five assemblies 50a,b,c,d,e are shown, the number of assemblies can be from 1 to 10, more preferably from about 2 to about 8, and more preferably from about 3 to 6 assemblies 50.

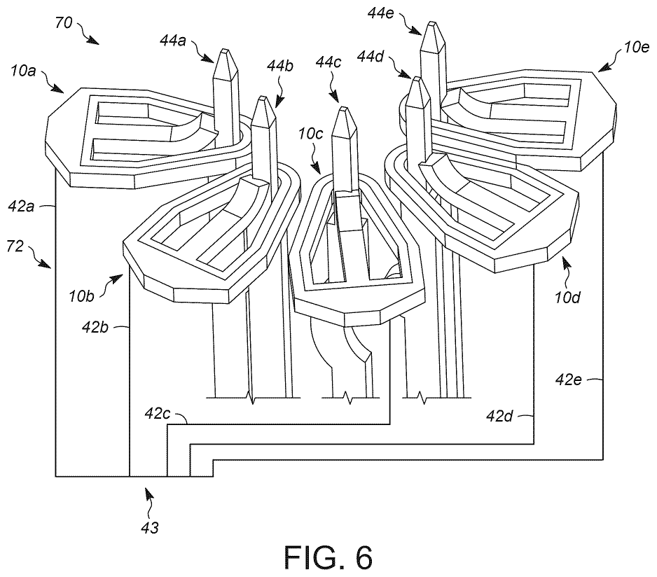

FIG. 6 shows a stamped array of conductors sometimes referred to as a lead frame 72 connected to the array 70 of assemblies 50. The lead frame 72 has five electrical conductive elements 42a,b,c,d,e, one of each associated with socket terminal 10a,b,c,d,e, respectively. The number of electrical conductive elements 42 can be selected from the same range as the assemblies 50, or can have more or less conductive elements 42. The lead frame 72 is constructed by placing a set of stamped copper alloy conductors in a carrier structure and over-molding a thermoplastic material over the carrier structure and the conductors. The carrier structure retains the conductors in a space relationship from each other during the over-molding process. The material applied during the over-molding process flows over and between the electrical conductors in the lead frame 72 isolating and insulating each conductor from the other in the lead frame. Preferably, the number of conductive elements 42 in the lead frame 72 is equal to the number of terminals 10.

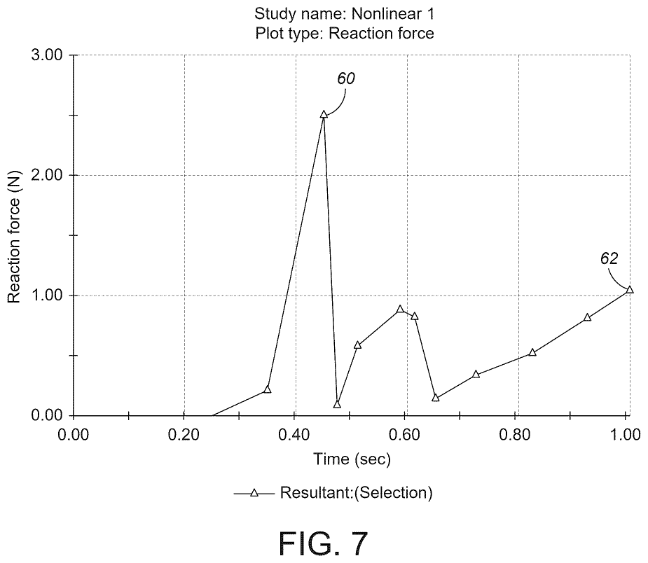

FIG. 7 is a graph showing an initial reaction force 60 and a final position reaction force 62 upon insertion of the pin terminal 44 into the pin socket 24 measured on the surface 48 (FIGS. 3 and 4). Preferably, the initial reaction force 60 and the final position reaction force 62 is less than about 7 N, more preferably less than about 6N, even more preferably less than about 5 N, and most preferably less than about 3 N. As shown in FIG. 7, the initial reaction force is 2.5 N and the final position reaction force is 1.0 N. This reaction force is normal to the surface 48 along the direction of insertion which is in alignment with the pin axis.

FIG. 8 shows the deflectable end 23 of socket terminal 10a of a first assembly 50a in contact with the pin terminal 44a at a corner 61 and the first face 52. The deflectable end 23 of socket terminal 10b of a second assembly 50b contacts pin terminal 44b at a corner 61 and the third face 53. The deflectable end 23 of socket terminal 10c of a third assembly 50c contacts pin terminal 44c at a corner 61 and the third face 53. The deflectable end 23 of socket terminal 10d of a fourth assembly 50d contacts pin terminal 44d at a corner 61 and the second face 55. The deflectable end 23 of socket terminal 10e of a fifth assembly 50e contacts pin terminal 44e at a corner 61 and the second face 55. In each case, only one single corner 61 of the pin terminal 44 is in engagement with the deflectable end 23 of the respective socket terminal 10. Moreover, in a preferred embodiment, no corners 61 of the pin terminal 44 are in contact with the interior of the bight 57, which further reduces insertion force. In other words, all corners 61 of the pin terminal are spaced apart from the interior of the bight 57.

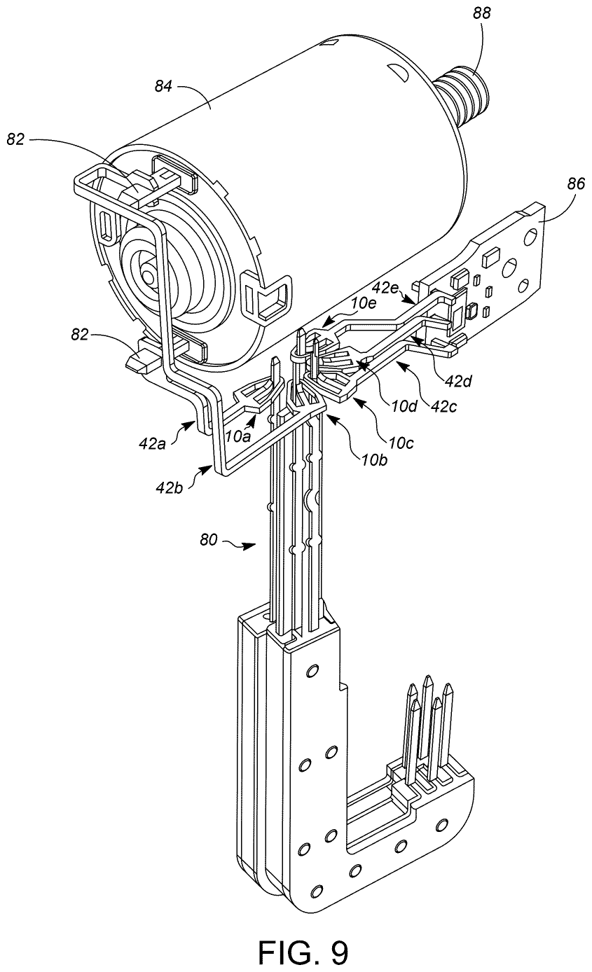

FIG. 9 shows a bridge-frame 80 containing electrical conductors 42a,b,c,d,e housed internally in the bridge-frame 80. A first set of two conductors 42a, b are connected to power terminals 82 on an actuator motor 84 to provide electrical power to the motor 84. A second set of three conductors 42c,d,e return feedback signals from a valve sensor board 86 to a motherboard (not shown). The actuator motor 82 has a motor shaft 88 connected through a gear system (not shown) to a valve. The actuator motor 82, when energized rotates the motor shaft 88, causing the valve to be selectively positioned. The valve sensor board 86 transmits the valve's position via feedback signals to the motherboard (not shown) through conductors 42c,d,e.

Now is described a method for making an electrical connection between a terminal and a pin terminal. The steps include providing an electrical terminal comprising a body for connecting to a conductor and defining a loop, a tab extending into the loop having a deflectable end projecting away from the body and providing a pin socket between the loop and the tab. Another step requires providing a pin terminal having a generally polygonal shape in horizontal cross-section. The method further includes the step of inserting the pin terminal into the socket using a force of less than about 7 N. The method can also include the optional step of attaching a conductive element to the body. The conductive element can be a single wire or multiple wires or multiple conductors in a lead frame.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. An electrical terminal comprising:
a body for connecting to a conductor and a loop, a tab extending into the loop having a deflectable end projecting away from the body and providing a pin socket between the loop and the tab.

2. The terminal of claim 1 comprising a strip with a generally rectangular section and a radiused section that forms the loop.

3. The terminal of claim 1 wherein the tab has a proximal end with first upper surface generally coplanar with a top surface of the body.

4. The terminal of claim 3 wherein the tab has a distal end having a second upper surface extending beyond the top surface.

5. The terminal of claim 1 wherein the body is of an electrically conductive material.

6. The terminal of claim 1 wherein the pin socket has an initial reaction force less than about 7 N upon insertion of an appropriately sized pin terminal.

7. An electrical assembly comprising:
a socket terminal for connecting to a conductor and defining a loop, a tab extending into the loop having a deflectable end projecting away from the loop and providing a pin socket between the loop and the tab; and
a pin terminal positioned in the pin socket in contact with the tab and within the loop.

8. The assembly of claim 7 wherein the pin terminal has a square-pyramidal-shaped insertion surface.

9. The assembly of claim 7 wherein the socket terminal has tapering segments that extend to a radiused section.

10. The assembly of claim 9 wherein the radiused section 28 defines a bight 57 that completes the loop 22.

11. The assembly of claim 7 wherein the tab has a proximal end with a first upper surface generally coplanar with a top surface of the tab, and a distal end with a second upper surface extending beyond the top surface.

12. The assembly of claim 7 wherein the tapering segments extend from a body.

13. The assembly of claim 7 wherein the pin socket has an initial reaction force less than about 7 N upon insertion of the pin terminal.

14. A method for making an electrical connection comprising:
providing an electrical socket terminal comprising a body for connecting to a conductor and defining a loop, a tab extending into the loop having a deflectable end projecting away from the body and providing a pin socket between the loop and the tab;
providing a pin terminal; and,
inserting the pin terminal into the socket.

15. The method of claim 14 further comprising the step of attaching a conductive element to the body.

16. The method of claim 15 wherein the conductive element is a lead-frame conductor.

17. The method of claim 14 wherein the pin terminal contacts the tab and is within the loop.

18. The method of claim 14 wherein the pin terminal has a square-pyramidal-shaped insertion surface.

19. The assembly of claim 14 wherein the socket terminal has tapering segments that extend to a radiused section.

20. The method of claim 15 wherein the tab has a proximal end with a first upper surface generally coplanar with a top surface of the tab, and a distal end with a second upper surface extending beyond the top surface.
